(19) United States
(12) Patent Application Publication
(10) Pub. No.: US 2026/0188149 A1
(43) Pub. Date: Jul. 2, 2026

(54) PROJECTION DEVICE AND OPERATING METHOD THEREOF

(71) Applicant: SAMSUNG ELECTRONICS CO., LTD., Suwon-si (KR)

(72) Inventors: Jaehee JUNG, Suwon-si (KR); Yongman Son, Suwon-si (KR); Kyungmin Lee, Suwon-si (KR); Jaesung You, Suwon-si (KR); Sungsik Park, Suwon-si (KR)

(73) Assignee: SAMSUNG ELECTRONICS CO., LTD., Suwon-si (KR)

(21) Appl. No.: 19/438,202

(22) Filed: Dec. 31, 2025

Related U.S. Application Data
(63) Continuation of application No. PCT/KR2025/020509, filed on Dec. 3, 2025.

(30) Foreign Application Priority Data
Dec. 27, 2024 (KR) 10-2024-0199331

(51) Int. Cl. G09G 3/00; G03B 21/14; G06F 3/16

(52) U.S. Cl. CPC G09G 3/001; G06F 3/165; G03B 21/142; G09G 2340/0464; G09G 2354/00

(57) ABSTRACT

A projection device that is movable includes a projection portion that projects image contents. The projection device identifies, based on a call command for the projection device, a target location at which a projection is performed, identifies first image content corresponding to the target location, obtains setting information for projecting the first image content, moves to the target location while performing a presetting operation based on the setting information, and controls the projection portion to project the first image content based on the presetting operation being completed.

### CROSS-REFERENCE TO RELATED APPLICATIONS

This application is a continuation of International Application No. PCT/KR 2025/020509, filed on Dec. 3, 2025, which claims priority to Korean Patent Application No. 10-2024-0199331, filed on Dec. 27, 2024, in the Korean Intellectual Property Office, the disclosures of which are incorporated by reference herein in their entireties.

### BACKGROUND

### 1. Field

The disclosure relates to a projection device for projecting image content and an operating method thereof.

### 2. Description of Related Art

Projection devices are used to project videos onto a screen or space. The projection devices include projectors, devices that provide virtual reality (VR), augmented reality (AR), or mixed reality (MR), etc.

Projection devices are used in various fields. For example, projection devices are used for lectures and presentation in classrooms or conference rooms and for projecting movies onto a screen in movie theaters. VR, AR, or MR devices provide a user wearing any of these devices with the experience of watching a movie in a theater by displaying a video on a screen (display) positioned near the user's eyes.

Recently, projection devices that are portable and include dual lenses to perform both long-distance and close-up projection have been developed. Also, projection devices project various image content appropriately according to a projection environment.

### SUMMARY

According to an aspect of the disclosure there is provided projection device configured to be movable and including: a projection portion configured to project image content; memory storing one or more instructions; and at least one processor including processing circuitry, wherein the one or more instructions, when executed by the at least one processor individually or collectively, cause the projection device to: identify, based on a call command for the projection device, a target location at which a projection is performed, identify first image content corresponding to the target location, obtain setting information for projecting the identified first image content, move to the target location while performing a presetting operation based on the setting information, and control the projection portion to project the first image content based on the presetting operation being completed.

The call command for the projection device may include voice input of a user or a control command received from an external device.

The call command for the projection device may include identification information for the target location.

The one or more instructions, when executed by the at least one processor individually or collectively, may cause the projection device to: store, as a database, a location of the projection device that executes the first image content, information on the first image content, and information related to execution of the first image content.

The one or more instructions, when executed by the at least one processor individually or collectively, may cause the projection device to: identify, based on the database, the first image content corresponding to the target location, and obtain, based on the database, the setting information for projecting the first image content.

The setting information may include at least one of information on a projection lens configured to project the first image content, volume information corresponding to the first image content, sound information corresponding to the first image content, or screen information corresponding to the first image content.

The projection portion may include: a first lens having a first focal length and a second lens having a second focal length longer than the first focal length, wherein the projection device further may include: a lens driver configured to change a projection lens such that the image content is projected through any one of the first lens or the second lens, and wherein the one or more instructions, when executed by the at least one processor individually or collectively, may cause the projection device to: move to the target location while controlling the lens driver to change the projection lens from the first lens to the second lens or change the projection lens from the second lens to the first lens, based on the information on the projection lens configured to project the first image content.

The first lens may include at least one of a short focal length lens or an ultra-short focal length lens, and the second lens may include a long focal length lens.

The projection device may include a speaker configured to output an audio signal, wherein the one or more instructions, when executed by the at least one processor individually or collectively, may cause the projection device to: move to the target location while controlling the speaker to adjust a sound mode or a volume of the audio signal, based on the volume information corresponding to the first image content or the sound information corresponding to the first image content. 1

The one or more instructions, when executed by the at least one processor individually or collectively, may cause the projection device to: identify a user based on the call command for the projection device, identify second image content corresponding to the identified user and the target location, obtain second setting information for projecting the identified second image content, and move to the target location while performing the presetting operation based on the second setting information.

According to an aspect of the disclosure, there is provided an operating method of a projection device configured to be movable, the operating method including: identifying, based on a call command for the projection device, a target location at which projection is performed; identifying first image content corresponding to the target location; obtaining setting information for projecting the first image content; moving to the target location while performing a presetting operation based on the setting information; and projecting the first image content based on the presetting operation being completed.

The operating method may include: receiving the call command for the projection device, the call command including a voice input of a user or a control command received from an external device.

The identifying of the target location may include identifying the target location based on identification information for the target location included in the call command of calling the projection device.

The operating method may include: storing, as a database, a location of the projection device which executes the first image content, information on the fi

The identifying the first image content may include: identifying, based on the database, the first image content corresponding to the target location, and wherein the obtaining the setting information may include: obtaining, based on the database, the setting information for projecting the first image content.

The setting information may include at least one of information on a projection lens configured to project the first image content, volume information corresponding to the first image content, sound information corresponding to the first image content, or screen information corresponding to the first image content.

The performing of the presetting operation based on the setting information may include: moving to the target location while changing the projection lens from a first lens having a first focal length to a second lens having a second focal length longer than the first focal length or from the second lens to the first lens, based on the information on the projection lens configured to project the first image content.

The performing of the presetting operation based on the setting information may include: moving to the target location while adjusting a volume of a speaker or a sound mode, based on the volume information corresponding to the first image content or the sound information corresponding to the first image content.

The operating method may include: identifying a user based on the call command of calling the projection device; identifying second image content corresponding to the identified user and the target location; obtaining second setting information for projecting the second image content; and moving to the target location, while performing the presetting operation based on the second setting information.

According to an aspect of the disclosure, there is provided a non-transitory computer-readable recording medium having stored thereon a program configured to perform an operating method including: identifying, based on a call command for a projection device, a target location at which projection is performed; identifying first image content corresponding to the target location; obtaining setting information for projecting the first image content; moving to the target location while performing a presetting operation based on the setting information; and projecting the first image content based on the presetting operation being completed.

### DESCRIPTION OF DRAWINGS

The above and other aspects, features, and advantages of embodiments of the disclosure will be more apparent from the following description taken in conjunction with the accompanying drawings, in which:

FIG. 1 shows a projection device according to an embodiment of the disclosure;

FIG. 2 shows an operation of a lens driver according to an embodiment of the disclosure;

FIG. 3 is a flowchart illustrating a method, performed by a projection device according to an embodiment of the disclosure, of storing information about image content to be executed according to a location of the projection device;

FIG. 4 is a view for describing an operation, performed by a projection device according to an embodiment of the disclosure, of projecting different pieces of image content at different locations;

FIGS. 5A and 5B illustrate an example of a database stored on a projection device according to an embodiment of the disclosure;

FIG. 6 is a flowchart illustrating a method, performed by a projection device according to an embodiment of the disclosure, of performing a presetting operation according to a location at which image content will be projected;

FIGS. 7 and 8 are reference views for describing operations of a projection device according to an embodiment of the disclosure;

FIGS. 9 and 10 are views for describing an operation, performed by a projection device according to an embodiment of the disclosure, of performing preloading according to a user;

FIG. 11 is a view for describing a presetting operation of a projection device according to an embodiment of the disclosure; and

FIG. 12 is a block diagram showing a configuration of a projection device according to an embodiment of the disclosure.

### DETAILED DESCRIPTION

Terms used in this disclosure will be briefly described, and the disclosure will be described in detail.

Although general terms being widely used in the present disclosure were selected as terminology used in the disclosure while considering the functions of the disclosure, they may vary according to intentions of one of ordinary skill in the art, judicial precedents, the advent of new technologies, and the like. Terms arbitrarily selected by the applicant of the disclosure may also be used in a specific case. In this case, their meanings will be described in detail in the detailed description of the disclosure. Hence, the terms must be defined based on the meanings of the terms and the contents of the entire disclosure, not by simply stating the terms themselves.

It will be understood that when a certain part “includes” a certain component, the part does not exclude another component but can further include another component, unless the context clearly dictates otherwise. As used herein, the terms “part”, “portion”, “module”, or “unit” refers to a unit that can perform at least one function or operation, and may be implemented as a software or hardware component or as a combination of software and hardware.

Hereinafter, embodiments of the disclosure will be described in detail with reference to the accompanying drawings so that the disclosure may be readily implemented by those skilled in the art. However, the disclosure is not limited to these embodiments of the disclosure, and may be embodied in various other forms. In the drawings, parts irrelevant to the description are omitted for the simplicity of explanation, and like reference numerals refer to like elements throughout the disclosure.

In embodiments of the disclosure, the term “user” means a person who controls system, functions, or operations, and may include a developer, a manager, or an installation engineer.

Also, in embodiments of the disclosure, the term ‘image’ or ‘picture’ may represent a still image, a moving image configured with a plurality of successive still images (or frames), or video.

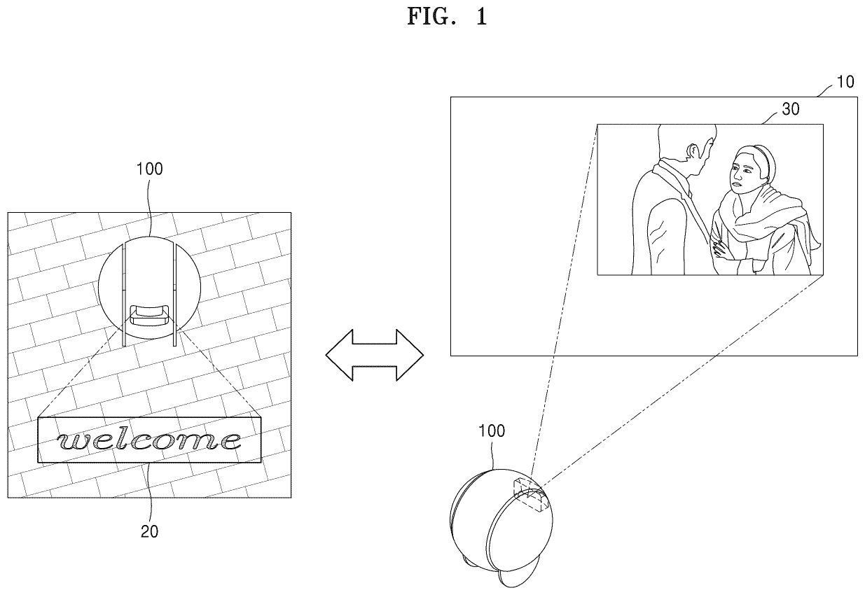

FIG. 1 shows a projection device according to an embodiment of the disclosure.

Referring to FIG. 1, a projection device 100 according to an embodiment of the disclosure may project an image onto a screen. The screen onto which an image is projected may be configured in various ways. In a case where the projection device 100 according to an embodiment of the disclosure is a projector, the screen may be a physical space onto which an image is projected. For example, the screen may include a wall, a floor, a ceiling, or a screen made of a fabric material. However, the disclosure is not limited thereto.

In a case where the projection device 100 according to an embodiment of the disclosure is a device that provides Virtual Reality (VR), Augmented Reality (AR), or Mixed Reality (MR), the screen may be a display included in the projection device 100. For example, the device that provides VR, AR, or MR may be implemented in the form of a glasses-type wearable device including a head mounted display (HMD) that may be mounted on a head, and may include a display. The display may be a transparent display or an opaque display. The device that provides VR, AR, or MR may output (display) image content to the display.

Hereinafter, for convenience of description, although a case in which the projection device 100 is a projector is shown and described as an example, the following description may also be applied in the same way to a case in which the projection device 100 is a device that provides VR, AR, or MR.

The projection device 100 according to an embodiment of the disclosure may include a projection portion including a first lens having a first focal length and a second lens having a second focal length, wherein the second focal length is longer than the first focal length. For example, the first lens may include a short focal length lens or an ultra-short focal length lens, and the second lens may include a long focal length lens.

Hereinafter, for convenience of description, the first lens is assumed to be a short focal length lens or an ultra-short focal length lens, and the second lens is assumed to be a long focal length lens.

The projection device 100 according to an embodiment of the disclosure may identify a location, size, shape, etc. of a screen or space onto which image content will be projected, and project the image content by using the first lens or the second lens as a projection lens, based on the identified location, size, shape, etc. of the screen or space.

When the projection device 100 according to an embodiment of the disclosure projects image content onto a screen or space located (located within a preset distance from the projection device 100) close to the projection device 100 the projection device 100 may project the image content by using the first lens. For example, as shown in FIG. 1, when the projection device 100 projects first image content 20 onto a floor located close to the projection device 100, the projection device 100 may project the first image content 20 by using the first lens.

When the projection device 100 according to an embodiment of the disclosure projects image content onto a screen or space that is far away (spaced a distance greater than a preset distance) from the projection device 100, the projection device 100 may project the image content by using the second lens. For example, as shown in FIG. 1, when the projection device 100 projects second image content 30 onto a wall 10 that is far away from the projection device 100, the projection device 100 may project the second image content 30 by using the second lens.

When the projection device 100 needs to project image content onto a screen or space that is far away from the projection device 100 after projecting image content onto a screen or space located close to the projection device 100 by using the first lens, the projection device 100 may change the projection lens from the first lens to the second lens.

Also, when the projection device 100 according to an embodiment of the disclosure needs to project image content onto a screen or space located close to the projection device 100 after projecting image content onto a screen or space that is far away from the projection device 100 by using the second lens, the projection device 100 may change the projection lens from the second lens to the first lens.

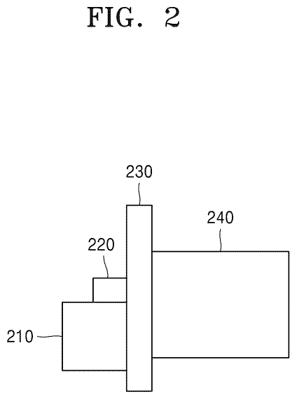

Also, when the projection device 100 according to an embodiment of the disclosure may change the projection lens by using a lens driver. This will be described in detail with reference to FIG. 2. An operation of changing the projection lens from the first lens to the second lens or from the second lens to the first lens in the projection device 100 may require a certain time. A user who uses the projection device 100 may experience inconvenience of having to wait for the time required for the operation of changing the lens, and the time required for the operation of changing the lens may interrupt the user from watching image content.

The projection device 100 according to an embodiment of the disclosure may be movable. The projection device 100 may include a driver and move through the driver. Movements of the projection device 100 may include not only a driving movement in which the projection device 100 moves and thus changes a location thereof, but also a rotational movement in which the projection device 100 rotates to change a projection direction at the same position. However, the disclosure is not limited thereto.

In the case in which the projection device 100 according to an embodiment of the disclosure needs to move, the projection device 100 may preload, while the projection device 100 moves, one or more pieces of image content that is expected to be used by a user and change a hardware setting to project the image content. The preloading of image content provides for a faster and more personalized experience to a user. Also, when the projection lens needs to change to project image content, the projection device 100 may change the projection lens while moving. Therefore, according to the projection device 100 receiving an execution request for the preloaded image content, the projection device 100 according to an embodiment of the disclosure may quickly execute the image content without a loading process or hardware setting and project the image content.

Hereinafter, operations, performed by the projection device 100 according to an embodiment of the disclosure, of identifying image content that is predicted to be executed, preloading the identified image content, and performing settings in advance to project the image content will be described in detail with reference to the drawings.

FIG. 2 shows an operation of a lens driver according to an embodiment of the disclosure.

Referring to FIG. 2, the lens driver according to an embodiment of the disclosure may include a sliding type structure 230. A first lens 210 and a second lens 220 may be mounted on one side of the sliding type structure 230. The first lens 210 may include a short focal length lens or an ultra-short focal length lens, and the second lens 220 may include a long focal length lens. For example, the lens driver may move the sliding type structure 230 such that the first lens 210 or the second lens 220 is aligned with a center of an optical system 240. The optical system 240 may include optical components that are used for the projection device 100 to project image content.

The lens driver according to an embodiment of the disclosure may include a motor or a rail and may move the sliding type structure 230 by using the motor or the rail. Alternatively, the lens driver may include a rack and pinion structure. The rack and pinion structure, which is a structure for converting a rotational movement to a linear movement, may include a rack gear and a pinion gear. The rack gear may be a long, flat bar shaped gear that performs linear motion, and the pinion gear may be a small, circular gear that performs rotational motion. While the pinion gear rotates, the rack gear engaged with the pinion gear may move and thus, rotational motion may be converted into linear motion. The first lens 210 and the second lens 220 according to an embodiment of the disclosure may be connected to the rack gear and move according to a movement of the rack gear. However, the disclosure is not limited thereto.

Referring to FIG. 2, the sliding type structure 230 may move (or slide) in a first direction and a second direction that is opposite to the first direction. For example, when the projection lens needs to change from the second lens 220 to the first lens 210 while the second lens 220 is aligned with a central axis of the optical system 240, the sliding type structure 230 may move (or slide) in the second direction (for example, a up direction) to align the first lens 210 with the central axis of the optical system 240. Alternatively, in the case in which the lens driver includes the rack and pinion structure, the rack gear may move in the first direction and in the second direction. For example, when the projection lens needs to change from the second lens 220 to the first lens 210 while the second lens 220 is aligned with the central axis of the optical system 240, the lens driver may move the rack gear in the second direction (for example, the up direction) to align the first lens 210 with the central axis of the optical system 240. Accordingly, the projection device 100 may project image content through the first lens 210.

Meanwhile, when the projection lens needs to change from the first lens 210 to the second lens 220 while the first lens 210 is aligned with the central axis of the optical system 240, the sliding type structure 230 may move (or slide) in the first direction (for example, a down direction) to align the second lens 220 with the central axis of the optical system 240. Alternatively, in the case in which the lens driver includes the rack and pinion structure and the projection lens needs to change from the first lens 210 to the second lens 220 while the first lens 210 is aligned with the central axis of the optical system 240, the lens driver may move the rack gear in the first direction (for example, the down direction) to align the second lens 220 with the central axis of the optical system 240. Accordingly, the projection device 100 may project image content through the second lens 220.

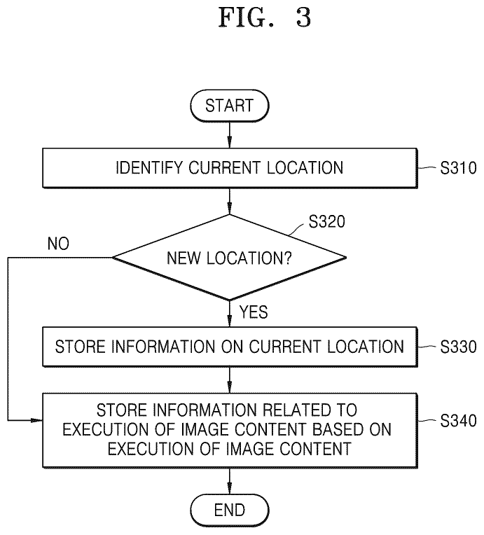

FIG. 3 is a flowchart illustrating a method, performed by a projection device according to an embodiment of the disclosure, of storing information on image content to be executed according to a location of the projection device.

Referring to FIG. 3, the projection device 100 according to an embodiment of the disclosure may identify a current location of the projection device 100 (S310).

For example, the projection device 100 may obtain information on a surrounding environment of the projection device 100 and identify a current location of the projection device 100 based on the information on the surrounding environment. The projection device 100 may use Simultaneous Localization and Mapping (SLAM) technology to generate a map of surroundings while moving and identify a location of the projection device 100. The projection device 100 may obtain the information on the surrounding environment based on information detected by a sensor. For example, the projection device 100 may collect data on a surrounding environment by using a camera, a Light Detection and Ranging (LiDAR) sensor, a radar sensor, an infrared sensor, an ultrasonic sensor, etc., thereby obtaining information on the surrounding environment.

The projection device 100 may recognize a structure of a surrounding environment and generate map data based on the recognized structure of the surrounding environment. The projection device 100 may identify a current location based on the map data. However, the disclosure is not limited thereto.

The projection device 100 according to an embodiment of the disclosure may identify whether the current location is a new location (S320).

According to the current location being a new location, the projection device 100 according to an embodiment of the disclosure may store information on the current location (S330).

For example, according to the current location being a new location, the projection device 100 may generate map data for the current location and store the map data together with identification information of the current location. However, the disclosure is not limited thereto.

While the projection device 100 according to an embodiment of the disclosure executes image content and projects the image content, the projection device 100 may store information related to execution of the image content (S340).

For example, the projection device 100 may count the number of times which the corresponding image content has been executed at the corresponding location. Also, the projection device 100 may store information on whether a lens used to project the image content is the first lens (a short focal length lens or an ultra-short focal length lens) or the second lens (a long focal length lens), information on a volume or sound mode in which an audio signal of the image content is output, information on a screen that projects the image content, a location or direction of a screen onto which the image content is projected, etc. In addition, in the case in which the projection device 100 executes the image content and is capable of identifying a user who watches the image content, the projection device 100 may store information on the user. However, the disclosure is not limited thereto.

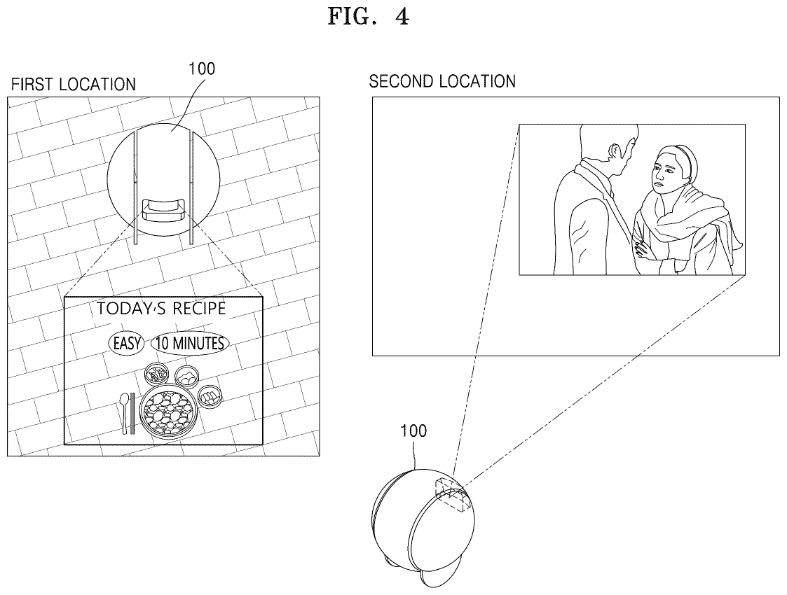

FIG. 4 is a view for describing an operation, performed by a projection device according to an embodiment of the disclosure, of projecting different pieces of image content at different locations.

Referring to FIG. 4, the projection device 100 according to an embodiment of the disclosure may execute a first application (for example, a recipe application) at a first location (for example, a kitchen).

The projection device 100 may identify a current location of the projection device 100 and according to the identified current location being a new location, the projection device 100 may store information on the first location. For example, the projection device 100 may generate map data for the first location and store the map data, and may store a name for the first location as a ‘kitchen’ based on a user input. However, the disclosure is not limited thereto.

The projection device 100 according to an embodiment of the disclosure may store identification information (for example, an image content name) of image content executed at the first location, the number of executions of the image content, projection lens information, audio setting information, screen setting information, etc. in correspondence to the first location. As shown in FIG. 4, while the first application is executed at the first location, the projection device 100 may store execution information of the first application in correspondence to the first location. For example, the projection device 100 may increase the number of executions of the first application at the first location by one and store the number of executions. Also, the projection device 100 may store information about the first lens (a short focal length lens or an ultra-short focal length lens) used while the first application is projected. Also, the projection device may store audio setting information (for example, a speaker volume level ‘10’ ) of audio output while the first application is projected. Also, the projection device 100 may store information on a location or direction of a screen (for example, a floor) onto which the first application is projected, but the disclosure is not limited thereto.

The projection device 100 according to an embodiment of the disclosure may execute a second application (for example an over-the-top (OTT) application) at a second location (for example, a living room).

The projection device 100 may identify a current location of the projection device 100, and according to the identified current location being a new location, the projection device 100 may store information on the second location. For example, the projection device 100 may generate map data for the second location and store the map data, and may store a name of the second location as a ‘living room’, but the disclosure is not limited thereto.

The projection device 100 according to an embodiment of the disclosure may store identification information of image content executed at the second location, the number of executions of the image content, projection lens information, audio setting information, screen setting information, etc., in correspondence to the second location. As shown in FIG. 4, according to the second application being executed at the second location, the projection device 100 may store execution information of the second application in correspondence to the second location. For example, the projection device 100 may increase the number of executions of the second application at the second location by one and store the number of executions. Also, the projection device 100 may store information about the second lens (a long focal length lens) used while the second application is projected. Also, the projection device 100 may store audio setting information (for example, a speaker volume level ‘20’ and a sound mode ‘theater mode’ ) of audio output while the second application is projected. Also, the projection device 100 may store information on a location or direction of a screen (for example, a wall) onto which the second application is projected, but the disclosure is not limited thereto.

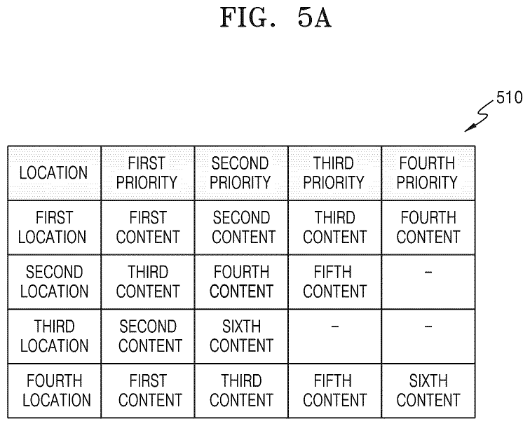

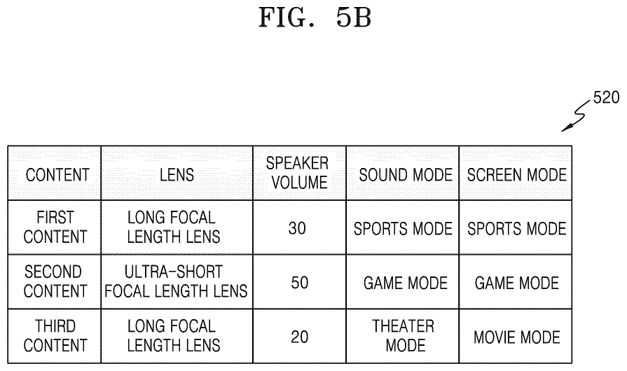

FIGS. 5A and 5B illustrate an example of database stored in a projection device according to an embodiment of the disclosure.

Referring to FIG. 5A, the projection device 100 according to an embodiment of the disclosure may store priority information 510 of image content according to locations as database.

The projection device 100 may count the numbers of executions of image content according to locations, and store priority information of the image content based on the counted numbers of executions. For example, according to the numbers of executions of image content at the first location increasing in the order of the number of executions of first content, the number of executions of second content, the number of executions of third content, and the number of executions of fourth content, priorities may be set in the order of the first content, the second content, the third content, and the fourth content.

Also, the projection device 100 may store priority information of image content executed a preset number of times or more at each location. For example, according to image content executed the preset number of times or more at a second location being the third content, the fourth content, and the fifth content, priorities of the third content, the fourth content, and the fifth content may be set based on the number of executions of the third content, the number of executions of the fourth content, and the number of executions of the fifth content, but the disclosure is not limited thereto.

As illustrated in FIG. 5B, the projection device 100 according to an embodiment of the disclosure may store, for each piece of image content, setting information 520 for projecting the image content as database.

Based on a lens setting, a speaker volume setting, a sound mode setting, a screen information setting, etc. when the projection device 100 reproduces image content and projects the image content, the projection device 100 may store setting information for projecting the image content as database.

For example, in the case in which the projection device 100 uses a long focal length lens as a projection lens or the number of times which the projection device 100 has used a long focal length lens is a preset number of times or more when the projection device 100 projects the first content, the projection device 100 may store lens setting information corresponding to the first content as ‘long focal length lens (second lens)’. Also, in the case in which the projection device 100 sets a speaker volume to ‘30’ and a sound mode to ‘sports mode’ when the projection device 100 projects the first content, the projection device 100 may store volume setting information corresponding to the first content as ‘30’ and sound setting information corresponding to the first content as ‘sports mode’. Also, in the case in which the projection device 100 sets screen information to ‘sports mode’ when the projection device 100 projects the first content, the projection device 100 may store screen setting information corresponding to the first content as ‘sports mode’.

In the case in which a projection lens setting, a speaker volume setting, a sound mode setting, or a screen information setting when the projection device 100 projects the first content is different from setting information stored in the database, the projection device 100 may change or update the setting information stored in the database, but the disclosure is not limited thereto.

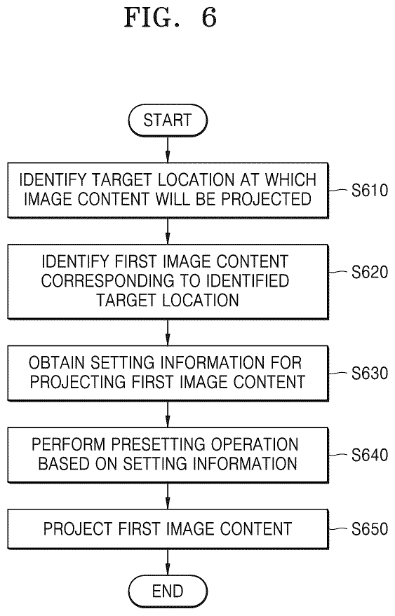

FIG. 6 is a flowchart illustrating a method, performed by a projection device according to an embodiment of the disclosure, of performing a presetting operation according to a location at which image content will be projected.

Referring to FIG. 6, the projection device 100 according to an embodiment of the disclosure may identify a target location at which image content will be projected (S610).

The projection device 100 according to an embodiment of the disclosure may receive a call command for the projection device 100. For example, the projection device 100 may receive a user's voice input of calling the projection device 100. The projection device 100 may include a microphone and receive a user's voice input through the microphone.

Alternatively, the projection device 100 may receive a call command for the projection device 100 from an external device. For example, the external device may receive a user input of calling the projection device 100 and transmit a call command to the projection device 100.

The projection device 100 may recognize identification information of a target location included in the call command by recognizing the user's voice. The projection device 100 may identify the target location based on the identification information of the target location. For example, according to the projection device 100 receiving a user's voice input of “come to the living room”, the projection device 100 may perform voice recognition to recognize a location name of ‘living room’ which is a prestored location from the user's voice input. Accordingly, the projection device 100 may identify the target location as ‘living room’.

Alternatively, an external device may transmit a call command to the projection device 100 based on a user input of designating ‘living room’ as a call location. In this case, the call command received by the projection device 100 may include a command of designating ‘living room’ as a call location. The projection device 100 may identify the ‘living room’ included in the call command as a target location.

However, the above-described methods are only examples, and the projection device 100 may identify a target location by various methods.

The projection device 100 according to an embodiment of the disclosure may identify first image content corresponding to the identified target location (S620).

For example, the projection device 100 may identify the first image content corresponding to the identified target location by using the priority information 510 shown in FIG. 5A and described above. According to the identified target location being ‘living room (second location)’, the projection device 100 may identify third content that has been most frequently executed at the second location.

Alternatively, the projection device 100 may identify a preset number (for example, three) of pieces of image content (for example, the third content, the fourth content, and the fifth content) in the order in which the image content have been more frequently executed at the second location, but the disclosure is not limited thereto.

The projection device 100 according to an embodiment of the disclosure may obtain setting information for projecting the first image content (S630).

For example, the projection device 100 may obtain setting information corresponding to the identified third content by using the database 520 shown in FIG. 5B and described above. The setting information for the third content may include, but is not limited to, a projection lens of ‘long focal length lens’, a speaker volume of ‘20’, a sound mode of ‘theater mode’, and a screen mode of ‘movie mode’.

The projection device 100 according to an embodiment of the disclosure may perform a presetting operation based on the obtained setting information (S640).

For example, the projection device 100 may move to the second location which is the target location, while changing, when a current projection lens is the first lens (a short focal length lens or an ultra-short focal length lens), the projection lens to the second lens (a long focal length lens), adjusting a speaker volume to ‘20’, changing a sound mode to ‘theater mode’, and setting a screen mode to be projected to ‘movie mode’.

Also, the projection device 100 may perform preloading of the third content. Preloading may be loading or initializing required data or resource in advance to quickly execute the corresponding content. A preloading operation may have been set in advance for each piece of content. For example, the projection device 100 may initialize or preload data or a resource required to execute the third content on a background.

Alternatively, the projection device 100 may preload the fourth content having a second priority and the fifth content having a third priority, in addition to the third content having a first priority at the second location (living room). In this case, the number of pieces of content to be preloaded may depend on performance of a processor and memory of the projection device 100.

Accordingly, when the projection device 100 arrives at the target location, the projection device 100 may be in a state capable of quickly executing the third content.

According to the projection device 100 receiving a command of requesting execution of the first image content, the projection device 100 may quickly execute the first image content preloaded and project the first image content (S650).

For example, according to the projection device 100 arriving at the second location and receiving a command of requesting execution of the third content, the projection device 100 may quickly execute the third content and project the third content in the state of having been set to setting information corresponding to the third content.

Because, while the projection device 100 moves to the second location, operations of setting a projection lens, setting a speaker volume, setting a sound mode, and setting a screen to project the third content are performed in advance, the projection device 100 which receives a command of requesting execution of the third content may quickly project the third content without having to wait for a time for which the setting operations are performed.

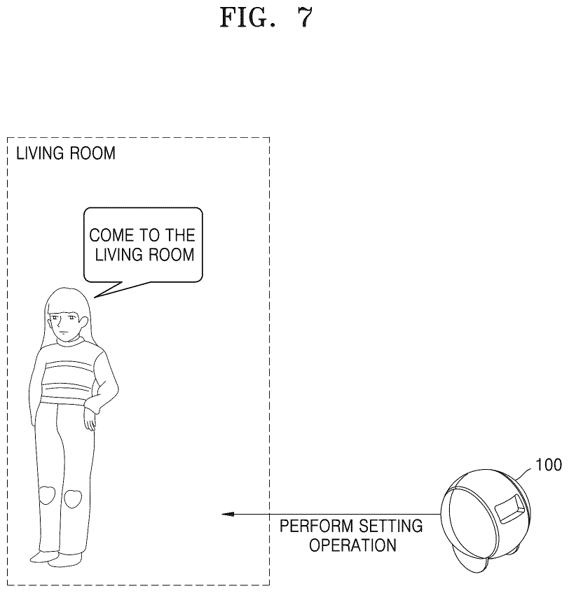

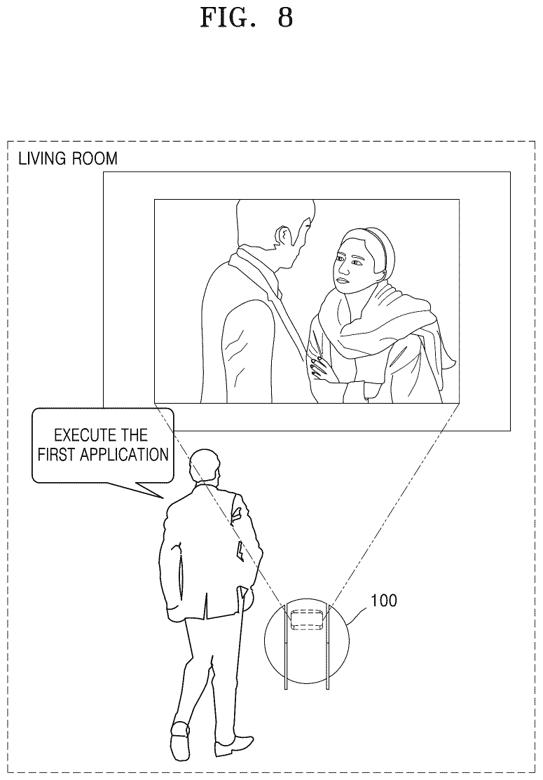

FIGS. 7 and 8 are reference views for describing operations of a projection device according to an embodiment of the disclosure.

Referring to FIG. 7, the projection device 100 according to an embodiment of the disclosure may receive a user's voice input of “come to the living room”. The projection device 100 may identify ‘living room’ as a target location based on a location name of ‘living room’ included in the user's voice command.

The projection device 100 may identify image content corresponding to the ‘living room’ based on database stored in advance. Image content that has been most frequently executed in the ‘living room’ may be a first application. Also, second and third most frequently executed image contents in the ‘living room’ may be second and third applications.

The projection device 100 may obtain setting information corresponding to the first application. For example, the setting information corresponding to the first application may include a projection lens of ‘long focal length lens’, a speaker volume of ‘20’, and a sound mode of ‘theater mode’.

While the projection device 100 moves to the ‘living room’, the projection device 100 may change the first lens to the second lens (a long focal length lens) when a current projection lens is the first lens (a short focal length lens or an ultra-short focal length lens), adjust the volume of the speaker to ‘20’, and change the sound mode to ‘theater mode’. Also, the projection device 100 may preload or initialize data or a resource required to execute the first application on a background. At this time, the projection device 100 may also preload or initialize resources or data for executing second and third applications that have second and third highest execution counts in the living room, but the disclosure is not limited thereto.

Referring to FIG. 8, when the projection device 100 arrives at the ‘living room’, the first application may have been preloaded on the background, the projection lens may have changed to the second lens, the volume of the speaker may have been adjusted to ‘20’, and the sound mode may have been set to the ‘theater mode’.

The projection device 100 may receive a user's voice command of “execute the first application”. Because the first application has already been preloaded on the background, the projection device 100 may quickly execute the first application and project the first application.

Because the projection device 100 has performed setting operations for projecting the first application in advance, the projection device 100 may, when a request for projecting the first application is received, quickly project the first application in an optimal state for a user.

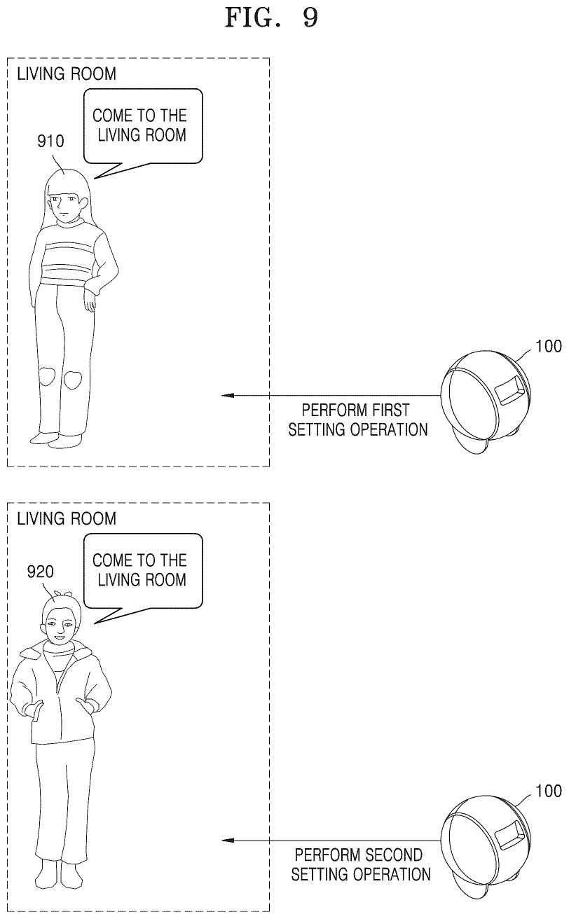

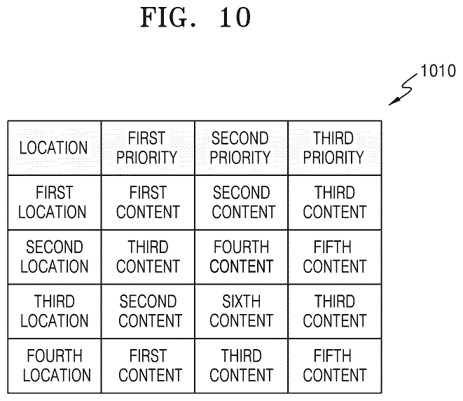

FIGS. 9 and 10 are views for describing an operation, performed by a projection device according to an embodiment of the disclosure, of performing preloading according to a user.

Referring to FIG. 9, the projection device 100 may receive a voice input of “come to the living room” from a first user 910. The projection device 100 may analyze the voice input, and according to the received voice input being a voice from the first user 910 and including a location name of ‘living room’, the projection device 100 may identify the ‘living room’ as a target location.

Alternatively, in the case in which the projection device 100 receives a call command from a wearable device which a user wears or a portable terminal which the user possesses, the projection device 100 may identify an external device that has transmitted the call command to thereby identify the user of the external device. For example, according to the projection device 100 receiving a call command of “move to the living room” from a first user's terminal, the projection device 100 may identify the ‘first user’ as a user and the ‘living room’ as a target location.

The projection device 100 may identify image content corresponding to the ‘first user’ and ‘living room’ by using database stored in advance.

The projection device 100 according to an embodiment of the disclosure may store information on image content that has been most frequently executed at each of a plurality of locations for each user, as database 1010, as shown in FIG. 10.

For example, in the case in which the first user has most frequently executed first content at a first location, third content at a second location, second content at a third location, and the first content at a fourth location, the projection device 100 may store image content corresponding to the first user and the first location as the first content, image content corresponding to the first user and the second location as the third content, image content corresponding to the first user and the third location as the second content, and image content corresponding to the first user and the fourth location as the first content.

Also, in the case in which a second user has most frequently executed the second content at the first location, fourth content at the second location, sixth content at the third location, and the third content at the fourth location, the projection device 100 may store image content corresponding to the second user and the first location as the second content, image content corresponding to the second user and the second location as the fourth content, image content corresponding to the second user and the third location as the sixth content, and image content corresponding to the second user and the fourth location as the third content.

The projection device 100 may identify image content corresponding to the first user and ‘living room (first location)’ as the first content, based on the database 1010 stored in advance.

The projection device 100 may obtain setting information for projecting the first content. For example, referring to FIG. 5B, setting information corresponding to the first content may include, but is not limited to, a projection lens of ‘long focal length lens’, a speaker volume of ‘30’, a sound mode of ‘sports mode’, and a screen mode of ‘sports mode’.

The projection device 100 may move to the ‘living room’ while performing a presetting operation (first setting operation) based on the setting information. The projection device 100 may change, when a current projection lens is the first lens (a short focal length lens or an ultra-short focal length lens), the current projection lens to the second lens (a long focal length lens), adjust the volume of the speaker to ‘30’, change the sound mode to the ‘sports mode’, and change the screen mode to the ‘sports mode’. Also, the projection device 100 may preload or initialize a resource or data for executing the first content on a background.

The projection device 100 may receive a voice input of ‘come to the living room’ from a second user 920. The projection device 100 may analyze the voice input, and according to the voice input being a voice from the second user 920 and including a location name of ‘living room’, the projection device 100 may identify the ‘living room’ as a target location.

Alternatively, in the case in which the projection device 100 receives a call command of ‘move to the living room’ from the second user's terminal, the projection device 100 may identify the second user 920 as a user and ‘living room’ as a target location.

The projection device 100 may identify image content corresponding to the second user and ‘living room’ as the second content by using the database 1010 stored in advance.

The projection device 100 may obtain setting information for projecting the second content. For example, referring to FIG. 5B, the setting information corresponding to the second content may include, but not limited to, a projection lens of ‘ultra-short focal length lens, a speaker volume of ‘50’, a sound mode of ‘game mode’, and a screen mode of ‘game mode’.

The projection device 100 may move to the ‘living room’ while performing a presetting operation (second setting operation) based on the setting information. The projection device 100 may change, when a current projection lens is the second lens (a long focal length lens), the current projection lens to the first lens (an ultra-short focal length lens), adjust the volume of the speaker to ‘50’, change the sound mode to the ‘game mode’, and change the screen mode to the ‘game mode’. Also, the projection device 100 may preload or initialize a resource or data for executing the second content on the background.

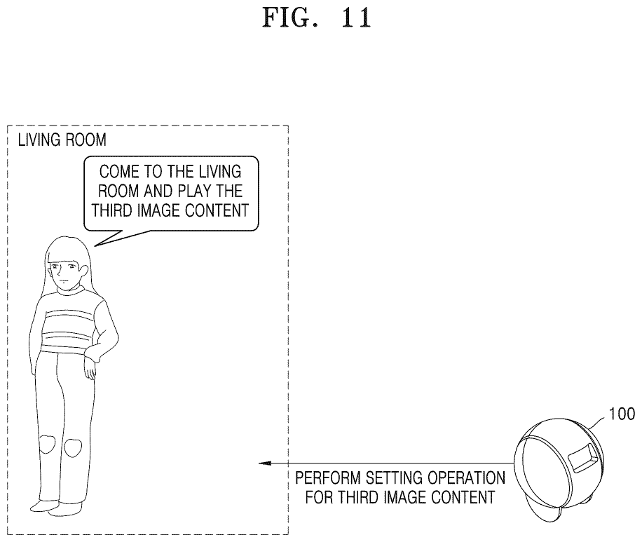

FIG. 11 is a view for describing a presetting operation of a projection device according to an embodiment of the disclosure.

Referring to FIG. 11, the projection device 100 according to an embodiment of the disclosure may receive a call command for the projection device 100. For example, the projection device 100 may receive a user's voice input of calling the projection device 100. Alternatively, the projection device 100 may receive a call command for the projection device 100 from an external device.

The call command may include identification information of a target location and identification information of image content. The projection device 100 may identify the target location and the image content to be projected, based on the call command. For example, according to the projection device 100 receiving a user's voice input of “come to the living room and play the third image content”, the projection device may recognize a location name of ‘living room’ which is a location stored in advance from the user's voice input, and identify a target location as ‘living room’. Also, the projection device 100 may recognize a content name of ‘third image content’ from the user's voice command and identify image content to be projected as ‘third content’.

The projection device 100 according to an embodiment of the disclosure may obtain setting information for projecting the third image content.

For example, the projection device 100 may obtain setting information for projecting the identified third content by using the database f shown in FIG. 5B and described above. The setting information for the third image content may include a projection lens of ‘long focal length lens’, a speaker volume of ‘20’, a sound mode of ‘theater mode’, and a screen mode of ‘movie mode’.

The projection device 100 according to an embodiment of the disclosure may move to the living room which is a target location, while changing, when a current projection lens is the first lens (a short focal length lens or an ultra-short focal length lens), the current projection lens to the second lens (a long focal length lens), adjust the volume of the speaker to ‘20’, change the sound mode to the ‘theater mode’, and change the screen mode to the ‘movie mode’.

Also, the projection device 100 may preload the third content. Preloading may be loading or initializing required data in advance to quickly execute the corresponding content. For example, the projection device 100 may initialize or preload a resource required to execute the third content on the background

Therefore, when the projection device 100 arrives at the target location (living room), the projection device 100 may be in a state capable of quickly executing the third content without having to wait for a time for which the setting operations are performed. When the projection device 100 arrives at the living room, the projection device 100 may quickly execute the third content and project the third content because presetting operations corresponding to the third content have already been completed.

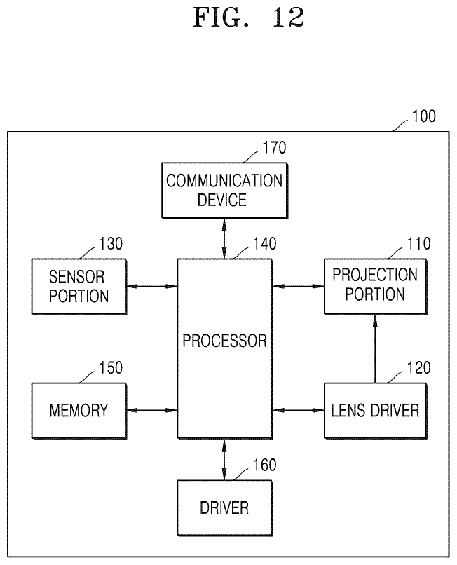

FIG. 12 is a block diagram showing a configuration of a projection device according to an embodiment of the disclosure.

Referring to FIG. 12, the projection device 100 according to an embodiment of the disclosure may include a sensor portion 130, a projection portion 110, a processor 140, memory 150, a lens driver 120, a driver 160, and a communication device 170.

The sensor portion 130 according to an embodiment of the disclosure may detect surroundings of the projection device 100. The sensor portion 130 may include, but is not limited to, a distance sensor, an image sensor, a depth sensor, and an infrared sensor.

The distance sensor according to an embodiment of the disclosure may detect a distance to a surrounding object. For example, the distance sensor may include, but is not limited to, an ultrasonic distance sensor that measures a distance using ultrasonic waves, an infrared distance sensor that measures a distance using infrared waves, a laser distance sensor that measures a distance using laser, etc.

The image sensor according to an embodiment of the disclosure may obtain an image frame, such as a still image or a moving image. For example, the image sensor may capture an image around the projection device 100. In this case, the image captured by the image sensor may be processed by the processor 140 or a separate image processor.

The depth sensor according to an embodiment of the disclosure may obtain depth information of one or more objects included in a space. Depth information may correspond to a distance from the depth sensor to a specific object, and the longer distance from the depth sensor to the specific object, the greater depth value. The depth sensor according to an embodiment of the disclosure may obtain depth information of an object by various methods, for example, at least one of a time of flight (TOF) method, a stereo image method, or a structured light method.

The depth sensor according to an embodiment of the disclosure may include at least one camera, and may obtain depth information of an actual space included in a field of view (FOV) of the camera included in the depth sensor.

Also, the sensor portion 130 may include, but is not limited to, an acceleration sensor, a position sensor, a temperature/humidity sensor, an illuminance sensor, a geomagnetic sensor, a gyroscope sensor, and a microphone, in addition to the distance sensor, the image sensor, the depth sensor, and the infrared sensor.

The sensor portion 130 may transfer detected information to the processor 140. The processor 140 may obtain surrounding environment information based on the detected information. The surrounding environment information may include, but is not limited to, at least one of a size, location, and type of a screen positioned near the projection device 100, a kind, size, and location of an object positioned near projection device 100, or motion information of the object.

For example, the processor 140 may recognize a surrounding environment structure around the projection device 100 based on the detected information, and generate map data based on the recognized surrounding environment structure. The processor 140 may identify a current location of the projection device 100 based on the map data, and control a movement or driving of the projection device 100.

The projection portion 110 according to an embodiment of the disclosure may project various image content, such as applications, movies, TV programs, videos, moving images, online streaming services, advertisement content, etc. but the disclosure is not limited thereto. Image content according to an embodiment of the disclosure may be image content stored in advance in the memory 150 or image content received from an external device through the communication device 170. Also, the image content may be a video subject to various image processing, such as decoding, scaling, noise filtering, frame rate conversion, resolution conversion, etc., by a video processor.

The projection portion 110 according to an embodiment of the disclosure may include a light source that generates light, a lens, etc. For example, the projection portion 110 may include the first lens having the first focal length and the second lens having the second focal length that is longer than the first focal length. The first lens may include at least one of a short focal length lens or an ultra-short focal length lens. The second lens may include a long focal length lens. Accordingly, the processor 140 may control the projection portion 110 to project media content such as movies and TV broadcast programs onto a distant screen by using the second lens. Also, the processor 140 may control the projection portion 110 to project image content (for example, a recipe video, a route guidance video, or a welcome mode video) that provides a message or information by using the first lens, but the disclosure is not limited thereto.

The lens driver 120 according to an embodiment of the disclosure may change the projection lens by changing positions of the first and second lenses included in the projection portion 110. For example, the lens driver 120 may include a sliding type structure, and the first lens and the second lens may be mounted on one side of the sliding type structure. The lens driver 120 may include a motor, a rail, etc., and may move the sliding type structure by using the motor, the rail, etc. However, the disclosure is not limited thereto.

The lens driver 120 may change the projection lens from the first lens to the second lens or from the second lens to the first lens.

Also, the projection portion 110 according to an embodiment of the disclosure may project various image content, such as movies, TV programs, videos, moving images, online streaming services, advertisement content, etc., but the disclosure is not limited thereto.

The driver 160 according to an embodiment of the disclosure may move the projection device 100 under control by the processor 140. For example, the driver 160 may move the projection device 100 or rotate the projection portion 110 according to a control signal received from the processor 140.

The processor 140 according to an embodiment of the disclosure may control overall operations of the projection device 100 and signal flow between the internal components of the projection device 100, and process data.

The processor 140 may include a single core, a dual core, a triple core, a quad core, and a multiple core. Also, the processor 140 may include a plurality of processors. For example, the processor 140 may be implemented with a main processor and a sub processor.

Also, the processor 140 may be configured with a hardware component that performs arithmetic, logic, and input/output operations and signal processing. The processor 140 may be configured with at least one of, for example, a Central Processing Unit, a microprocessor, a Graphic Processing Unit (GPU), Video Processing Unit (VPU), an Application Specific Integrated Circuits (ASICs), a Digital Signal Processors (DSPs), a Digital Signal Processing Devices (DSPDs), a Programmable Logic Devices (PLDs), a Field Programmable Gate Arrays (FPGAs), an Application Processor (AP), a Neural Processing Unit (NPU), or an artificial intelligence-specific processor designed with a hardware structure specialized for processing an artificial intelligence model, but the disclosure is not limited thereto. Also, according to an embodiment of the disclosure, the processor 140 may be implemented in the form of a System On Chip (SOC) into which at least one of the above-listed processors is integrated.

The memory 150 according to an embodiment of the disclosure may include, for example, a flash memory type, a hard disk type, a multimedia card micro type, and card type memory (for example, Secure Digital (SD) memory or eXtreme Digital (XD) memory), non-volatile memory including at least one of Read-Only Memory (ROM) or Electrically Erasable Programmable Read-Only Memory (EEPROM), magnetic memory, or an optical disk, and volatile memory such as Random Access Memory (RAM) or Static Random Access Memory (SRAM).

The memory 150 according to an embodiment of the disclosure may store various data, programs, or applications for driving and controlling the projection device 100.

Also, a program stored in the memory 150 may include one or more instructions. The program (one or more instructions) or application stored in the memory 150 may be executed by the processor 140.

The processor 140 according to an embodiment of the disclosure may be one or more processors. In the case in which one or more processors 140 are provided, the operations of the disclosure may be performed by the one or more processors 140 that individually or collectively execute an instruction and/or program stored in the memory 150.

In the case in which a method according to an embodiment of the disclosure includes a plurality of operations, the plurality of operations may be performed by a single or plurality of processors 140. For example, in the case in which a first operation, a second operation, and a third operation are performed by the method according to an embodiment of the disclosure, all of the first operation, the second operation, and the third operation may be performed by a first processor, or the first operation and the second operation may be performed by the first processor while the third operation may be performed by a second processor.

One or more processors according to an embodiment of the disclosure may be implemented as a single-core processor or a multi-core processor. In the case in which the method according to an embodiment of the disclosure includes a plurality of operations, the plurality of operations may be performed by a single core or by a plurality of cores included in the one or more processors.

The processor 140 according to an embodiment of the disclosure may individually or collectively execute one or more instructions stored in the memory 150 to identify a current location of the projection device 100. For example, the processor 140 may obtain surrounding environment information of the projection device 100 and identify a current location of the projection device 100 based on the surrounding environment information.

The processor 140 according to an embodiment of the disclosure may individually or collectively execute the one or more instructions stored in the memory 150 to, according to an identified current location being a new location, store information on the current location. For example, according to a current location being a new location, the processor 140 may generate map data for the current location and store the map data together with identification information of the current location, but the disclosure is not limited thereto.

The processor 140 according to an embodiment of the disclosure may individually or collectively execute the one or more instructions stored in the memory 150 to, while the projection device 100 executes image content and projects the image content, store information related to execution of the image content. For example, the processor 140 may count the number of times which the corresponding image content has been executed at the corresponding location. Also, the processor 140 may store information on whether a lens used to project the image content is the first lens (a short focal length lens or an ultra-short focal length lens) or the second lens (a long focal length lens), information on a volume or sound mode in which an audio signal of the image content is output, information on a screen that projects the image content, a location or direction of a screen onto which the image content is projected, etc. Also, the projection device 100 may execute the image content and store information about a user who watches the image content in the case in which the projection device 100 is capable of identifying a user, although not limited thereto.

The processor 140 according to an embodiment of the disclosure may individually or collectively execute one or more instructions stored in the memory 150 to store priority information of image content at each location as database. For example, the processor 140 may count the number of times which image content has been executed at each location and store priority information of the image content based on the count number of times. Also, the processor 140 may store priority information of image content executed a preset number of times or more at each location.

The processor 140 according to an embodiment of the disclosure may individually or collectively execute the one or more instructions stored in the memory 150 to store setting information 520 for projecting each piece of image content as database.

The processor 140 according to an embodiment of the disclosure may individually or collectively execute the one or more instructions stored in the memory 150 to identify a target location at which image content is projected. For example, the processor 140 may identify a target location by recognizing identification information of the target location included in a call command for the projection device 100. For example, when the projection device 100 receives a user's voice input of “come to the living room”, the projection device 100 may perform voice recognition to recognize a location name of ‘living room’ from the user's voice input. Accordingly, the processor 140 may identify a target location as ‘living room’. Alternatively, in the case in which a call command received from an external device includes a command specifying ‘living room’ as a call place, the processor 140 may identify a target location as ‘living room’. However, the above-described methods are only examples, and the processor 140 may identify a target location by various methods.

The processor 140 according to an embodiment of the disclosure may individually or collectively execute the one or more instructions stored in the memory 150 to identify first image content corresponding to the identified target location.

For example, the processor 140 may identify the first image content corresponding to the identified target location by using database stored in advance. According to the identified target location being the ‘living room’, the processor 140 may identify third content that has been most frequently executed in the ‘living room’. Alternatively, the processor may identify a preset number (for example, three) of pieces of image content (for example, the third image content, fourth content, and fifth content) in the order in which image content has been more frequently executed in the ‘living room’. However, the disclosure is not limited thereto.

The processor 140 according to an embodiment of the disclosure may individually or collectively execute the one or more instructions stored in the memory 150 to obtain setting information for projecting the first image content.

For example, the processor 140 may obtain setting information corresponding to the identified third content by using the database stored in advance. The setting information about the third content may include, but is not limited to, a projection lens of ‘long focal length lens’, a speaker volume of ‘20’, a sound mode of ‘movie mode’, and a screen mode of ‘movie mode’.

The processor 140 according to an embodiment of the disclosure may individually or collectively execute the one or more instructions stored in the memory 150 to perform a presetting operation based on the obtained setting information.

For example, the processor 140 may move to the ‘living room’ which is a target location, while changing, when a current projection lens is the first lens (a short focal length lens or an ultra-focal length lens), the current projection lens to the second lens (a long focal length lens), adjusting the volume of the speaker to ‘20’, changing the sound mode to ‘theater mode’, and setting the screen mode for projection to ‘movie mode’.

Also, the processor 140 may preload the third content. Preloading may be loading or initializing a required resource or data in advance to quickly execute the corresponding content. A preloading operation may have been set in advance for each piece of content. For example, the projection device 100 may initialize or preload a resource or data required to execute the third content on the background.

Alternatively, the processor 140 may preload the fourth content having a second priority and the fifth content having a third priority, in addition to the third content having a first priority in the ‘living room’. In this case, the number of pieces of content to be preloaded may depend on performance of the processor 140 and the memory 150. Therefore, when the projection device 100 arrives at the target location, the projection device 100 may be in a state capable of quickly executing the third content.

The processor 140 according to an embodiment of the disclosure may individually or collectively execute the one or more instructions stored in the memory 150 to, when a command requesting execution of first image content is received, quickly execute the first image content in the preloaded state and project the first image content.

For example, when the projection device 100 arrives at the ‘living room’ and receives a command of requesting execution of the third content, the processor 140 may quickly execute the third content in a state of having been set to setting information corresponding to the third content, and project the third content.

Because, while the projection device 100 moves to the ‘living room’, operations of setting a projection lens, setting a speaker volume, setting a sound mode, and setting a screen to project the third content are performed in advance, the processor 140 may, when the projection device 100 receives a command of requesting execution of the third content, quickly project the third content without having to wait for a time for which the setting operations are performed.

The communication device 170 may transmit/receive data or signals to/from an external device or server. The communication device 170 may include a communication interface including a communication circuit. For example, the communication device 170 may include a wireless-fidelity (Wi-Fi) module, a Bluetooth module, an infrared communication module, a wireless communication module, a local area network (LAN) module, an Ethernet module, and a wired communication module. In this case, each communication module may be implemented in the form of at least one hardware chip.

The Wi-Fi module and the Bluetooth module may perform communication by a Wi-Fi method and a Bluetooth method, respectively. In the case in which the Wi-Fi module or the Bluetooth module is used, various connection information, such as a service set identifier (SSID) and a session key, may be first transmitted/received, communication may be established through the connection information, and then various information may be transmitted/received. The wireless communication module may include at least one communication chip that performs communication according to various wireless communication standards, such as zigbee, 3rd Generation (3G), 3rd Generation Partnership Project (3GPP), Long Term Evolution (LTE), LTE Advanced (LTE-A), 4th Generation (4G), and 5th Generation (5G).

The communication device 170 according to an embodiment of the disclosure may receive a call command for the projection device 100 or a command of controlling the projection device 100 from an external device. Also, the communication device 170 may receive a video or image content to be projected from an external device.

The communication device 170 according to an embodiment of the disclosure may receive user information from a user terminal or a wearable device that a user wears.

Meanwhile, the block diagram of the projection device 100 shown in FIG. 12 may be a block diagram for an embodiment of the disclosure. Some components of the block diagram may be integrated or omitted, or another component may be added, according to specifications of the projection device 100 that is actually implemented. That is, two or more components may be integrated into one component, or one component may be separated into two or more components, as necessary. Also, functions performed in the individual blocks are provided to describe the embodiments, and the detailed operations or devices for the functions do not limit the scope of rights of the disclosure.

A projection device configured to be movable, according to an embodiment of the disclosure may include a projection portion configured to project image content, memory storing one or more instructions, and at least one processor configured to execute the one or more instructions.

The at least one processor according to an embodiment of the disclosure may individually or collectively execute the one or more instructions to cause the projection device to identify, based on a call command for the projection device, a target location at which projection is performed.

The at least one processor according to an embodiment of the disclosure may individually or collectively execute the one or more instructions to cause the projection device to identify first image content corresponding to the target location.

The at least one processor according to an embodiment of the disclosure may individually or collectively execute the one or more instructions to cause the projection device to obtain setting information for projecting the first image content.

The at least one processor according to an embodiment of the disclosure may individually or collectively execute the one or more instructions to cause the projection device to move to the target location while performing a presetting operation based on the setting information.

The at least one processor according to an embodiment of the disclosure may individually or collectively execute the one or more instructions to cause the projection device to project the first image content in a state of having completed the presetting operation.

The call command for the projection device according to an embodiment of the disclosure may include a user's voice input or a control command received from an external device.

The call command for the projection device according to an embodiment of the disclosure may include identification information for the target location.

The at least one processor according to an embodiment of the disclosure may individually or collectively execute the one or more instructions to cause the projection device to store information on a location of the projection device which executes the image content, information on the image content, and information related to execution of the image content as database.

The at least one processor according to an embodiment of the disclosure may individually or collectively execute the one or more instructions to cause the projection device to identify, based on the database, the first image content corresponding to the target location.

The at least one processor according to an embodiment of the disclosure may individually or collectively execute the one or more instructions to cause the projection device to obtain, based on the database, the setting information for projecting the first image content.

The setting information according to an embodiment of the disclosure may include at least one of information on a projection lens for projecting the first image content, volume information corresponding to the first image content, sound information corresponding to the first image content, or screen information corresponding to the first image content.

The projection portion according to an embodiment of the disclosure may include a first lens having a first focal length and a second lens having a second focal length that is longer than the first focal length.

The projection device according to an embodiment of the disclosure may further include a lens driver configured to change a projection lens such that the image content is projected through any one of the first lens or the second lens.

The at least one processor according to an embodiment of the disclosure may individually or collectively execute the one or more instructions to cause the projection device to move to the target location while controlling the lens driver to change the projection lens from the first lens to the second lens or from the second lens to the first lens based on projection lens information for projecting the first image content.

The first lens according to an embodiment of the disclosure may include at least one of a short focal length lens or an ultra-short focal length lens, and the second lens may include a long focal length lens.

The projection device according to an embodiment of the disclosure may further include a speaker configured to output an audio signal.

The at least one processor according to an embodiment of the disclosure may individually or collectively execute the one or more instructions to cause the projection device to move to the target location while controlling the speaker to adjust a sound mode or a volume of the audio signal based on volume information corresponding to the first image content or sound information corresponding to the first image content.

The at least one processor according to an embodiment of the disclosure may individually or collectively execute the one or more instructions to cause the projection device to identify a user based on a call command for the projection device.

The at least one processor according to an embodiment of the disclosure may individually or collectively execute the one or more instructions to cause the projection device to identify second image content corresponding to the identified user and the target location.

The at least one processor according to an embodiment of the disclosure may individually or collectively execute the one or more instructions to cause the projection device to obtain second setting information for projecting the second image content.

The at least one processor according to an embodiment of the disclosure may individually or collectively execute the one or more instructions to cause the projection device to move to the target location while performing a presetting operation based on the second setting information.

An operating method of a projection device configured to be movable, according to an embodiment of the disclosure may include identifying, based on a call command for the projection device, a target location at which projection is performed.

The operating method of the projection device configured to be movable, according to an embodiment of the disclosure may include identifying first image content corresponding to the target location.

The operating method of the projection device configured to be movable, according to an embodiment of the disclosure may include obtaining setting information for projecting the first image content.

The operating method of the projection device configured to be movable, according to an embodiment of the disclosure may include moving to the target location while performing a presetting operation based on the setting information.

The operating method of the projection device configured to be movable, according to an embodiment of the disclosure may include projecting the first image content in a state of having completed the presetting operation. For example, according to an embodiment, the operating method may include controlling the projection portion to project the first image content based on the presetting operation being completed.

The operating method of the projection device configured to be movable, according to an embodiment of the disclosure may further include receiving a call command for the projection device, the call command including a user's voice input or a control command received from an external device.

The identifying of the target location according to an embodiment of the disclosure may include identifying the target location based on identification information of the target location, included in the call command for the projection device.

The operating method of the projection device configured to be movable, according to an embodiment of the disclosure may further include storing a location of the projection device which executes the image content, information on the image content, and information related to execution of the image content, as database. For example, the projection device may store, as a database, a location of the projection device that executes the first image content, information on the first image content, and information related to execution of the first image content.

The identifying of the first image content according to an embodiment of the disclosure may include identifying, based on the database, the first image content corresponding to the target location.

The obtaining of the setting information according to an embodiment of the disclosure may include obtaining, based on the database, the setting information for projecting the first image content.

The setting information according to an embodiment of the disclosure may include at least one of information on a projection lens configured to project the first image content, volume information corresponding to the first image content, sound information corresponding to the first image content, or screen information corresponding to the first image content.

The performing of the presetting operation based on the setting information according to an embodiment of the disclosure may include moving to the target location, while changing the projection lens from a first lens having a first focal length to a second lens having a second focal length that is longer than the first focal length or from the second lens to the first lens, based on the information on the projection lens configured to project the first image content.

The performing of the presetting operation based on the setting information according to an embodiment of the disclosure may include moving to the target location, while adjusting a volume of a speaker or a sound mode, based on the volume information corresponding to the first image content or the sound information corresponding to the first image content.

The operating method of the projection device configured to be movable, according to an embodiment of the disclosure may include identifying a user based on the call command for the projection device.

The operating method of the projection device configured to be movable, according to an embodiment of the disclosure may include identifying second image content corresponding to the identified user and the target location.

The operating method of the projection device configured to be movable, according to an embodiment of the disclosure may include obtaining second setting information for projecting the second image content.

The operating method of the projection device configured to be movable, according to an embodiment of the disclosure may include moving to the target location while performing a presetting operation based on the second setting information.

The projection device according to an embodiment of the disclosure may reduce a time consumed to prepare projection by predicting image content to be projected according to a target location at which projection will be performed and performing a presetting operation based on setting information corresponding to the predicted image content while the projection device moves to the target location.

When the projection device according to an embodiment of the disclosure arrives at a target location and receives a projection request from a user, the projection device may project image content immediately without a waiting time, thereby improving a user's convenience.

The operating method of the projection device according to an embodiment of the disclosure may be implemented in the form of a program command form that can be executed by various computer means, and may be recorded on computer-readable media. The computer-readable media may also include, alone or in combination with program commands, data files, data structures, and the like. Program commands recorded in the media may be the kind specifically designed and constructed for the purposes of the disclosure or well-known and available to those of ordinary skill in the computer software field. Examples of the computer-readable media include magnetic media, such as hard disks, floppy disks, and magnetic tapes, optical media, such as CD-ROM and DVD, magneto-optical media such as floptical disks, and hardware devices, such as ROM, RAM, flash memory, and the like, specifically configured to store and execute program commands. Examples of the program commands include high-level language codes that can be executed on a computer through an interpreter or the like, as well as machine language codes produced by a compiler.

The operating method of the display device according to the disclosed embodiments may be included in a computer program product and provided. The computer program product may be traded between a seller and a purchaser as a commodity.

The computer program product may include a S/W program and computer-readable storage media in which the S/W program is stored. For example, the computer program product may include a product in the form of a S/W program (e.g., a downloadable app) that is electronically distributed through a manufacturer of an electronic device or an electronic marketplace (e.g., Google Play Store or AppStore). For electronic distribution, at least a part of the S/W program may be stored on storage media or may be created temporarily. In this case, the storage media may be storage media of a server of a manufacturer, a server of an electronic marketplace, or a relay server for temporarily storing the SW program.

The computer program product may include, in a system configured with a server and a client device, storage media of the server or storage media of the client device. Alternatively, when there is a third device (e.g., a smart phone) communicatively connected to the server or the client device, the computer program product may include storage media of the third device. Alternatively, the computer program product may include a S/W program itself transmitted from the server to the client device or to the third device, or from the third device to the client device.

In this case, one of the server, the client device, or the third device may execute the computer program product to perform the method according to the disclosed embodiments. Alternatively, two or more of the server, the client device, and the third device may execute the computer program product to distribute and perform the method according to the disclosed embodiments.

For example, a server (e.g., a cloud server or an artificial intelligence server, etc.) may execute a computer program product stored on the server to control a client device communicatively connected to the server to perform the method according to the disclosed embodiments.

A non-transitory computer-readable recording medium may have stored thereon a program configured to perform an operating method comprising: identifying, based on a call command for a projection device, a target location at which projection is performed; identifying first image content corresponding to the target location; obtaining setting information for projecting the first image content; moving to the target location while performing a presetting operation based on the setting information; and projecting the first image content based on the presetting operation being completed.

So far, although the embodiments have been described in detail, the scope of rights of the disclosure is not limited to these embodiments, and various modifications and variations made by those skilled in the art based on the fundamental concept of the disclosure as defined by the appended claims may also belong to the scope of rights of the disclosure.

1. A projection device configured to be movable, the projection device comprising:
a projection portion configured to project image content;
memory storing one or more instructions; and
at least one processor comprising processing circuitry,
wherein the one or more instructions, when executed by the at least one processor individually or collectively, cause the projection device to:
identify, based on a call command for the projection device, a target location at which a projection is performed,
identify first image content corresponding to the target location,
obtain setting information for projecting the first image content,
move to the target location while performing a presetting operation based on the setting information, and
control the projection portion to project the first image content based on the presetting operation being completed.

2. The projection device of claim 1, wherein the call command for the projection device comprises voice input of a user or a control command received from an external device.

3. The projection device of claim 1, wherein the call command for the projection device comprises identification information for the target location.

4. The projection device of claim 1, wherein the one or more instructions, when executed by the at least one processor individually or collectively, cause the projection device to:
store, as a database, a location of the projection device that executes the first image content, information on the first image content, and information related to execution of the first image content.

5. The projection device of claim 4, wherein the one or more instructions, when executed by the at least one processor individually or collectively, cause the projection device to:
identify, based on the database, the first image content corresponding to the target location, and
obtain, based on the database, the setting information for projecting the first image content.

6. The projection device of claim 5, wherein the setting information comprises at least one of information on a projection lens configured to project the first image content, volume information corresponding to the first image content, sound information corresponding to the first image content, or screen information corresponding to the first image content.

7. The projection device of claim 1, wherein the projection portion comprises:
a first lens having a first focal length and a second lens having a second focal length longer than the first focal length,
wherein the projection device further comprises:
a lens driver configured to change a projection lens such that the image content is projected through any one of the first lens or the second lens, and
wherein the one or more instructions, when executed by the at least one processor individually or collectively, cause the projection device to:
move to the target location while controlling the lens driver to change the projection lens from the first lens to the second lens or change the projection lens from the second lens to the first lens, based on the information on the projection lens configured to project the first image content.

8. The projection device of claim 7, wherein the first lens comprises at least one of a short focal length lens or an ultra-short focal length lens, and the second lens comprises a long focal length lens.

9. The projection device of claim 6,
further comprising a speaker configured to output an audio signal,
wherein the one or more instructions, when executed by the at least one processor individually or collectively, cause the projection device to:
move to the target location while controlling the speaker to adjust a sound mode or a volume of the audio signal, based on the volume information corresponding to the first image content or the sound information corresponding to the first image content.

10. The projection device of claim 1, wherein the one or more instructions, when executed by the at least one processor individually or collectively, cause the projection device to:
identify a user based on the call command for the projection device,
identify second image content corresponding to the user and the target location,
obtain second setting information for projecting the second image content, and
move to the target location while performing the presetting operation based on the second setting information.

11. An operating method of a projection device configured to be movable, the operating method comprising:
identifying, based on a call command for the projection device, a target location at which projection is performed;
identifying first image content corresponding to the target location;
obtaining setting information for projecting the first image content;
moving to the target location while performing a presetting operation based on the setting information; and
projecting the first image content based on the presetting operation being completed.

12. The operating method of claim 11, further comprising:
receiving the call command for the projection device, the call command comprising a voice input of a user or a control command received from an external device.

13. The operating method of claim 11, wherein the identifying of the target location comprises:
identifying the target location based on identification information for the target location included in the call command of calling the projection device.

14. The operating method of claim 11, further comprising:
storing, as a database, a location of the projection device which executes the first image content, information on the first image content, and information related to execution of the first image content.

15. The operating method of claim 14, wherein the identifying the first image content comprises:
identifying, based on the database, the first image content corresponding to the target location, and
wherein the obtaining the setting information comprises:
obtaining, based on the database, the setting information for projecting the first image content.

16. The operating method of claim 11, wherein the setting information comprises at least one of information on a projection lens configured to project the first image content, volume information corresponding to the first image content, sound information corresponding to the first image content, or screen information corresponding to the first image content.

17. The operating method of claim 16, wherein the performing of the presetting operation based on the setting information comprises:
moving to the target location while changing the projection lens from a first lens having a first focal length to a second lens having a second focal length longer than the first focal length or from the second lens to the first lens, based on the information on the projection lens configured to project the first image content.

18. The operating method of claim 16, wherein the performing of the presetting operation based on the setting information comprises:
moving to the target location while adjusting a volume of a speaker or a sound mode, based on the volume information corresponding to the first image content or the sound information corresponding to the first image content.

19. The operating method of claim 11, further comprising:
identifying a user based on the call command of calling the projection device;
identifying second image content corresponding to the user and the target location;
obtaining second setting information for projecting the second image content; and
moving to the target location, while performing the presetting operation based on the second setting information.

20. A non-transitory computer-readable recording medium having stored thereon a program configured to perform an operating method comprising:
identifying, based on a call command for a projection device, a target location at which projection is performed;
identifying first image content corresponding to the target location;
obtaining setting information for projecting the first image content;
moving to the target location while performing a presetting operation based on the setting information; and
projecting the first image content based on the presetting operation being completed.
